(19) United States
(12) Patent Application Publication
(10) Pub. No.: US 2024/0404241 A1
(43) Pub. Date: Dec. 5, 2024

(54) WORK ESTIMATION APPARATUS, WORK ESTIMATION METHOD, AND COMPUTER READABLE MEDIUM

(71) Applicant: Mitsubishi Electric Corporation, Tokyo (JP)

(72) Inventors: Keishi NISHIKAWA, Tokyo (JP); Takaya TANIGUCHI, Tokyo (JP); Kenji TAKII, Tokyo (JP)

(73) Assignee: Mitsubishi Electric Corporation, Tokyo (JP)

(21) Appl. No.: 18/799,718

(22) Filed: Aug. 9, 2024

Related U.S. Application Data
(63) Continuation of application No. PCT/JP2022/014679, filed on Mar. 25, 2022.

(51) Int. Cl. G06V 10/70; G06V 40/20

(52) U.S. Cl. CPC G06V 10/70; G06V 40/20

(57) ABSTRACT

A work estimation apparatus (100) includes a distance calculation unit (114) and a work estimation unit (116). The distance calculation unit (114) calculates a distance between a feature of which, joint movement data indicating a temporal transition of a position of each joint of a worker during work is converted into multidimensional waveform data, and converted by convolving the multidimensional waveform data converted using a convolution parameter, and each feature of which each piece of joint movement data that configures a plurality of pieces of joint movement data for learning the convolution parameter is converted into multidimensional waveform data, and each piece of multidimensional waveform data converted is converted by convolving using the convolution parameter. The convolution parameter is a parameter learned in a way that a distance between joint movement data indicating same work becomes relatively small and a distance between joint movement data indicating work that differ from each other becomes relatively large. The work estimation unit (116) estimates work content corresponding to inference target data based on each distance calculated.

### CROSS REFERENCE TO RELATED APPLICATIONS

This application is a Continuation of PCT International Application No. PCT/JP2022/014679, filed on Mar. 25, 2022, all of which is hereby expressly incorporated by reference into the present application.

### TECHNICAL FIELD

The present disclosure relates to a work estimation apparatus, a work estimation method, and a work estimation program.

### BACKGROUND ART

Demand for automatically estimating work content of a worker is rising. In technology disclosed in Patent Literature 1, first, a 2D image and a 3D image are obtained from an imaging device worn on a head of a photographer, posture (*1) of the imaging device is estimated based on the 3D image, an image feature (*2) is calculated based on the 2D image, and a posture feature (*3) is calculated by extracting a frame of the photographer from the 3D image. After that, activity of the photographer is recognized using a body shape parameter of the photographer and (*1) to (*3).

### CITATION LIST

### Patent Literature

Patent Literature 1: JP 2016-099982 A

### SUMMARY OF INVENTION

### Technical Problem

According to the technology disclosed in Patent Literature 1, the activity of the photographer can be robustly recognized despite differences in viewpoint and how a movement is viewed by difference in body shape of the photographer. On the other hand, even when a posture and the body shape is normalized, it will not be robust against a variation in movements between individuals. Here, a movement during work may differ depending on the worker even when the work content is a same. That is, there may be variations in the movement during work between the workers. Thus, when the work content of the worker is estimated using the technology that Patent Literature 1 discloses, the work content is to be estimated without explicitly considering the variation in the movement during work between the workers. Consequently, there is an issue where the estimation of the work content is prone to error in a case where there is a variation in the movement during work between the workers.

The present disclosure aims to make estimation of work content less prone to error even in a case where there is a variation in movement during work between workers.

### Solution to Problem

A work estimation apparatus according to the present disclosure includes:
a distance calculation unit to calculate a distance between a feature of which, regarding joint movement data that is time series data indicating a temporal transition of a position of each joint of a worker during work as inference target data, the inference target data is converted into multidimensional waveform data, and converted by convolving the multidimensional waveform data converted using a convolution parameter indicating weight found by learning, and each feature of which each piece of joint movement data that configures a plurality of pieces of joint movement data for learning the convolution parameter is converted into multidimensional waveform data, and each piece of multidimensional waveform data converted is converted by convolving using the convolution parameter; and
a work estimation unit to estimate work content corresponding to the inference target data based on each distance calculated, wherein
the convolution parameter is a parameter learned, using a loss function, in a way that a distance between each two pieces of joint movement data taken out from learning data consisting of a plurality of pieces of joint movement data associated with work labels indicating work content becomes relatively small in a case where the work labels associated with each two pieces of joint movement data are a same, and relatively large in a case where the work labels associated with each two pieces of joint movement data differ from each other.

### Advantageous Effects of Invention

According to the present disclosure, a distance calculation unit converts each piece of joint movement data into multidimensional waveform data, and calculates a distance between each feature converted by convolving each piece of multidimensional waveform data converted using a convolution parameter. After that, a work estimation unit estimates work content based on the distance calculated by the distance calculation unit. The convolution parameter is a parameter that is learned using a loss function in a way that a distance between each two pieces of joint movement data taken out from learning data consisting of a plurality of pieces of joint movement data associated with work labels indicating the work content becomes relatively small in a case where the work labels associated with each two pieces of joint movement data are a same, and relatively large in a case where the work labels associated with each two pieces of joint movement data differ from each other. Thus, according to the present disclosure, estimation of the work content can be made less prone to error even in a case where there is a variation in the movement during work between the workers.

### BRIEF DESCRIPTION OF DRAWINGS

FIG. 1 is a diagram illustrating an example of a configuration of a work estimation system 90 according to Embodiment 1.

FIG. 2 is a flowchart illustrating operation of a work estimation apparatus 100 at a time of learning according to Embodiment 1.

FIG. 3 is a diagram describing a process of a waveform conversion unit 113 according to Embodiment 1.

FIG. 4 is a diagram describing a loss function according to a variation of Embodiment 1.

FIG. 5 is a diagram describing the operation of the work estimation apparatus 100 at the time of learning according to Embodiment 1, (a) is a diagram describing a process to find a distance between data, and (b) is a diagram describing a change in the distance.

FIG. 6 is a flowchart illustrating operation of the work estimation apparatus 100 at a time of inference according to Embodiment 1.

FIG. 7 is a diagram describing a process of an information presentation unit 117 according to Embodiment 1.

FIG. 8 is a diagram describing a process of a joint information extraction unit 111 according to a variation of Embodiment 1.

FIG. 9 is a diagram describing a process of a work estimation apparatus 100 according to a variation of Embodiment 1.

FIG. 10 is a diagram describing the process of the work estimation apparatus 100 according to the variation of Embodiment 1.

FIG. 11 is a diagram describing a penalty according to a variation of Embodiment 1.

FIG. 12 is a diagram illustrating an example of a hardware configuration of a work estimation apparatus 100 according to a variation of Embodiment 1.

### DESCRIPTION OF EMBODIMENTS

In a description of the embodiment and in drawings, same reference signs are added to same elements and corresponding elements. Descriptions of elements having the same reference signs added will be suitably omitted or simplified. Arrows in diagrams mainly indicate flows of data or flows of processes. “Unit” may be suitably replaced with “circuit”, “step”, “procedure”, “process”, or “circuitry”.

### Embodiment 1

The present embodiment will be described in detail below by referring to the drawings.

### Description of Configuration

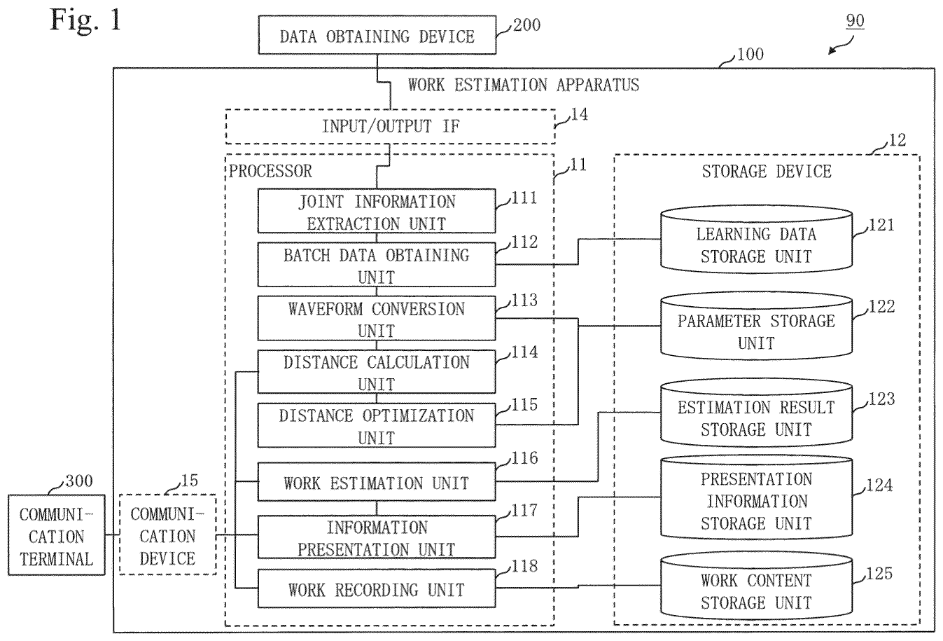

FIG. 1 illustrates an example of a configuration of a work estimation system 90 according to the present embodiment. The work estimation system 90 includes, as illustrated in FIG. 1, a work estimation apparatus 100, a data obtaining device 200, and a communication terminal 300. Each element that the work estimation system 90 includes is suitably connected communicatively, a plurality of each element may exist, or may be suitably configured integrally.

The data obtaining device 200 obtains outside world information that shows a movement of a worker such as a video, motion capture data, or the like. Data that the data obtaining device 200 obtains may be any data as long as the data is data from which joint movement data indicating a temporal transition of a position of each joint of the worker can be extracted. The joint movement data is time series data indicating the temporal transition of the position of each joint of the worker during work. The joint movement data typically consists of a set of time series data indicating a movement of each joint of a plurality of joints. The video is, as a specific example, consists of an RGB image, infrared image, or a depth image. The motion capture data may be data obtained without a marker or may be data obtained by markers worn on a human body.

The communication terminal 300 is a terminal having a communication function, and as a specific example, a smartphone or a PC (Personal Computer). The worker and the like possess the communication terminal 300.

The work estimation apparatus 100 is, as illustrated in FIG. 1, a computer that includes a processor 11, a storage device 12, an input/output IF 14, and a communication device 15 as hardware elements. The work estimation apparatus 100 may consist of a plurality of computers.

The work estimation apparatus 100 includes, as functional elements, a joint information extraction unit 111, a batch data obtaining unit 112, a waveform conversion unit 113, a distance calculation unit 114, a distance optimization unit 115, a work estimation unit 116, an information presentation unit 117, a work recording unit 118, a learning data storage unit 121, a parameter storage unit 122, an estimation result storage unit 123, a presentation information storage unit 124, and a work content storage unit 125.

The processor 11 is an IC (Integrated Circuit) that performs a calculation process, and controls hardware that the computer includes. The processor 11 is, as a specific example, a CPU (Central Processing Unit), a DSP (Digital Signal Processor), or a GPU (Graphics Processing Unit). The work estimation apparatus 100 may include a plurality of processors that replace the processor 11. The plurality of processors share roles of the processor 11.

The storage device 12 is a generic term for a volatile storage device and a non-volatile storage device, and as a specific example, consists of a main storage device and an auxiliary storage device.

The main storage device is typically a volatile storage device, and as a specific example, a RAM (Random Access Memory). Data stored in the main storage device is saved in the auxiliary storage device as necessary.

The auxiliary storage device is typically a non-volatile storage device, and as a specific example, a ROM (Read Only Memory), an HDD (Hard Disk Drive), or a flash memory. Data stored in the auxiliary storage device is loaded into the main storage device as necessary. The auxiliary storage device has stored a work estimation program.

The work estimation program is a program that causes a computer to enable functions of each unit that the work estimation apparatus 100 includes. The work estimation program is loaded into the main storage device, and executed by the processor 11. The functions of each unit that the work estimation apparatus 100 includes are enabled by software. The work estimation program may be recorded in a computer-readable non-volatile recording medium. The non-volatile recording medium is, as a specific example, an optical disc or a flash memory. The work estimation program may be provided as a program product.

Data used when executing the work estimation program, data obtained by executing the work estimation program, and the like are suitably stored in the storage device 12. Each unit of the work estimation apparatus 100 suitably utilizes the storage device 12. There is a case where data and information have an equal meaning. The storage device may be a device that is independent of the computer.

The input/output IF 14 is a port to which an input device and an output device are connected. The input/output IF 14 is, as a specific example, a USB (Universal Serial Bus) terminal. Input devices are, as specific examples, a keyboard and a mouse. The output device is, as a specific example, a display.

The communication device 15 is a receiver and a transmitter. The communication device 15 is, as a specific example, a communication chip or an NIC

### (Network Interface Card).

Each unit of the work estimation apparatus 100 may suitably use the input/output IF 14 and the communication device 15 when communicating with a different device and the like.

The joint information extraction unit 111 accepts data that the data obtaining device 200 obtained as input data, and extracts the joint movement data of the worker from the input data accepted. At this time, in a case where the input data is a video, the joint information extraction unit 111 can make use of known technology that extracts joint information using machine learning from the video. As a specific example of the known technology, OpenPose can be given. In a case where the input data is motion capture data, the joint information extraction unit 111 may make use of information that a device that executes motion capture provides.

At a time of learning, the batch data obtaining unit 112 randomly selects two or more pieces of joint movement data from the learning data storage unit 121, and outputs the joint movement data selected to the waveform conversion unit 113 as batch data.

At a time of inference, the batch data obtaining unit 112 outputs the joint movement data that the joint information extraction unit 111 extracted and a piece of joint movement data selected from the learning data storage unit 121 to the waveform conversion unit 113 as batch data.

Concerning the joint movement data obtained from the batch data obtaining unit 112, the waveform conversion unit 113 converts the joint movement data into multidimensional waveform data having each dimension of the frame as an element, and converts the multidimensional waveform data converted into a feature by convolving in a time direction using a convolution parameter. The waveform conversion unit 113 may convolve the multidimensional waveform data not only in the time direction but also in a dimensional direction using a convolutional neural network and the like. The convolution parameter is a parameter indicating weight ascertained by learning, is a parameter that affects a distance between two pieces of joint movement data, and is a parameter that is used in convolution. The convolution parameter is a parameter learned, using a loss function, in a way that a distance between each two pieces of joint movement data taken out from learning data becomes relatively small in a case where work labels associated with each two pieces of joint movement data are a same, and relatively large in a case where the work labels associated with each two pieces of joint movement data differ from each other. The distance between the two pieces of joint movement data may be a distance between data converted from each of the two pieces of joint movement data. The learning data consists of a plurality of pieces of joint movement data associated with work labels indicating work content. A conversion from the joint movement data to the multidimensional waveform data is, as a specific example, a process that creates data of which a coordinate position concerning each joint is arranged in an order of time, and combines each piece of data created in a direction of time. The feature may be something that can be formally expressed as waveform data of multiple dimensions.

The waveform conversion unit 113 accepts the joint movement data as inference target data, converts the inference target data received into multidimensional waveform data, and converts the multidimensional waveform data converted into a target feature that is a feature using the convolution parameter. The waveform conversion unit 113 accepts a plurality of pieces of joint movement data for learning the convolution parameter, converts each piece of joint movement data accepted into multidimensional waveform data, and converts each piece of multidimensional waveform data converted into a feature by convolution using the convolution parameter. The joint movement data for learning the convolution parameter is joint movement data associated with the work label, and does not have to be actually used for learning the convolution parameter. The work label is a label indicating the work content.

Concerning each dimension of the multidimensional waveform data, the waveform conversion unit 113 automatically extracts information representing essence of a work movement by correlating a value at each time in a waveform with different time and by weighting important parts such as posture, movement, and the like of a hand that represents work. At a time of learning the convolution parameter, the waveform conversion unit 113 interprets the joint movement data as the multidimensional waveform data, and calculates time series data concerning a feature indicating a movement of a joint.

The distance calculation unit 114 is also called an inter-data distance calculation unit, and calculates a distance between two pieces of joint movement data using the feature converted by the waveform conversion unit 113. The distance calculation unit 114 calculates a distance between the target feature and each feature converted. The distance that the distance calculation unit 114 calculates may be any indicator as long as the indicator can quantify some kind of difference, and as a specific example, is a value that is defined by Euclidean distance, Hamming distance, a cosine similarity, or an angular difference. A variation in movement during work is quantified by the distance that the distance calculation unit 114 calculates. The variation in the movement during work is generated by the movement during work differing depending on the worker even when the work content is a same. In work of tightening a nut, the variation in the movement during work, as a specific example, is a way of gripping a double wrench differing depending on the worker, a speed of turning the double wrench differing depending on the worker, or a turning width of the double wrench differing depending on the worker.

The distance optimization unit 115 is also called an inter-data distance optimization unit, learns the convolution parameter using the loss function and the learning data, and optimizes the convolution parameter in a way that a value of the loss function is minimized. At this time, the distance optimization unit 115 may use a known optimization method in a field of mathematical optimization. The loss function is a function indicating a loss concerning the distance, and is a function that feeds back on a loss in a way that a distance between data belonging to a same work class becomes relatively small and a distance between data belonging to work classes that differ from each other becomes relatively large. The loss function may be any function as long as the function is calculated based on information on the distance.

The work estimation unit 116 estimates work content corresponding to the inference target data based on each distance calculated by the distance calculation unit 114. Specifically, the work estimation unit 116 records each distance calculated by the distance calculation unit 114 in the estimation result storage unit 123, and suitably classifies the inference target data into work classes based on each distance recorded in the estimation result storage unit 123. The work content indicates a movement of the worker during work, a purpose of the work, or the like, and as a specific example, is tightening bolt A or installing part B. When classifying the data, the work estimation unit 116 may utilize a known classification technique based on a distance of K-nearest neighbor algorithm and the like, and may use a classifier such as a softmax classifier and the like. After that, the work estimation unit 116 outputs a result of classifying the data to the information presentation unit 117 and the work recording unit 118 as an estimation result of the work content.

The information presentation unit 117 generates presentation information. The presentation information is information that relates to the work content estimated, and is information that is to be presented to a worker corresponding to the inference target data. The presentation information is, as a specific example, information indicating a precaution relating to the work. Specifically, the information presentation unit 117 searches for data that the presentation information storage unit 124 has stored with the estimation result that the work estimation unit 116 outputted as a search query. At this time, the information presentation unit 117 may use a known search method. After that, the information presentation unit 117 generates the presentation information based on a search result, and outputs the presentation information generated to the communication terminal 300.

The work recording unit 118 records the work content estimated by the work estimation unit 116 and date and time that work corresponding to the work content estimated was executed to the work content storage unit 125.

The learning data storage unit 121 stores the plurality of pieces of joint movement data, learning data for learning the convolution parameter. Each piece of joint movement data that the learning data storage unit 121 stores is associated with the work label. Not all the learning data has to be used at the time of learning the convolution parameter.

The parameter storage unit 122 stores the convolution parameter.

The estimation result storage unit 123 stores the estimation result by the work estimation unit 116.

The presentation information storage unit 124 stores a presentation information DB (Database) that is a database consisting of data of which a name of the work and the work content are linked.

The work content storage unit 125 stores the work executed by the worker along with the date and the time that the work was executed.

### Description of Operation

An operation procedure of the work estimation apparatus 100 is equivalent to a work estimation method. A program that enables operation of the work estimation apparatus 100 is equivalent to the work estimation program.

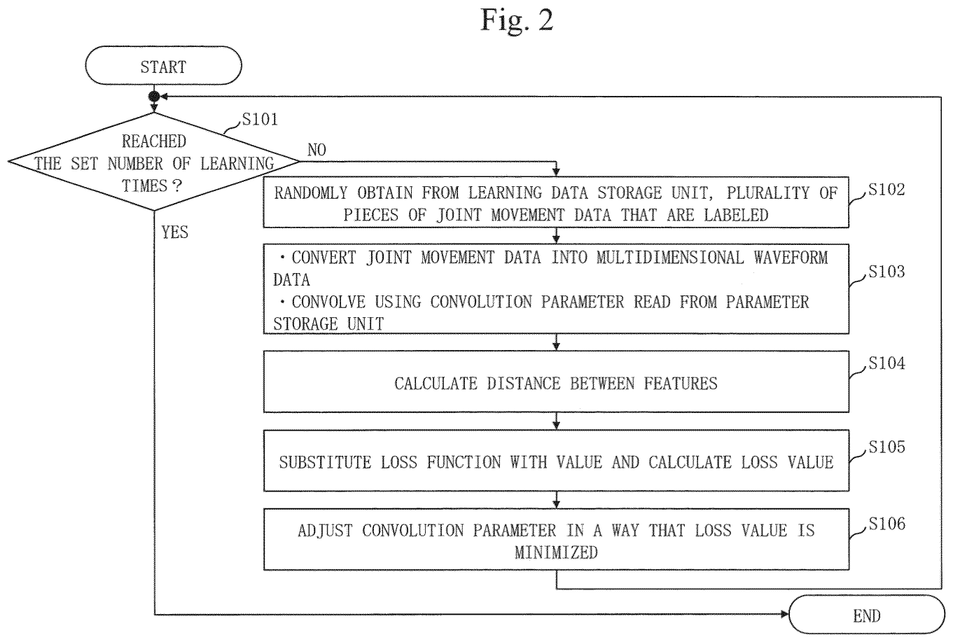

FIG. 2 is a flowchart illustrating an example of a process of the work estimation apparatus 100 at a time of learning. The process of the work estimation apparatus 100 at the time of learning will be described by referring to FIG. 2.

### (Step S101)

The work estimation apparatus 100 ends the process of the present flowchart in a case where the number of learning times reached the set number of learning times. In other cases, the work estimation apparatus 100 proceeds to step S102. The set number of learning times may be defined in any way.

### (Step S102)

The batch data obtaining unit 112 randomly obtains from the learning data storage unit 121, the plurality of pieces of joint movement data to which the work labels are associated.

### (Step S103)

The waveform conversion unit 113 converts each piece of joint movement data obtained in step S102 into multidimensional waveform data. After that, the waveform conversion unit 113 reads the convolution parameter from the parameter storage unit 122, and converts into a feature by convolving each piece of multidimensional waveform data using the convolution parameter read.

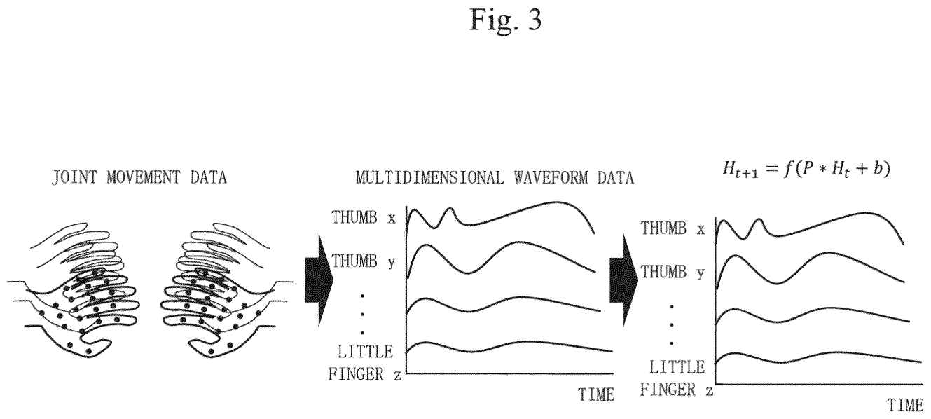

FIG. 3 is a diagram describing the joint movement data and a process of the present step. The joint movement data is data indicating the temporal transition of the position concerning each joint. Here, the position of each joint is represented by three-dimensional coordinates. The waveform conversion unit 113 converts the joint movement data into multidimensional waveform data having each dimension of each joint as an element. After that, the waveform conversion unit 113 converts the multidimensional waveform data converted into a feature.

### (Step S104)

The distance calculation unit 114 calculates a distance between each two features converted.

The distance calculation unit 114, as a specific example, calculates the distance between each two features using [Numerical Formula 1]. Details of [Numerical Formula 1] are disclosed in [Reference 1]. Here, a part that is enclosed by a norm symbol in [Numerical Formula 1] is a convolved value at each time of the two features. Function Φ is a function that determines whether or not to consider the distance between the two features based on a degree of similarity at each time of two pieces of convolved waveform data.

$${d}_{A B} = \frac{1}{{T}_{A} {T}_{B}} {\sum }_{i}^{T} {\sum }_{j}^{T} ‖ {ε ( A )}_{i} - {ε ( B )}_{j} ‖ Φ ( {ε ( A )}_{i} , {ε ( B )}_{j} ) \qquad [ Numerical Formula 1 ]$$

### [Reference 1]

Grabocka et al., “NeuralWarp: Time-Series Similarity with Warping Networks”, SIGKDD (Special Interest Group on Knowledge Discovery and Data Mining) '19, August 2019, Anchorage, Alaska, USA

The distance calculation unit 114, as a specific example, calculates the distance between each two features using [Numerical Formula 2], considering the degree of similarity as the distance in a case where the multidimensional waveform data is convolved in the time direction and in the dimensional direction. Here, wⱼ is a weight vector corresponding to class j, x is a feature, and θⱼ is an angle that a vector indicating the feature and the weight vector corresponding to work class j that is a work class to which the feature belongs form. The work class j is a class name assigned to certain work content.

$$cos ( {θ}_{j} ) = \frac{{w}_{j} \cdot x}{‖ {w}_{j} ‖ ‖ x ‖} \qquad [ Numerical Formula 2 ]$$

### (Step S105)

The distance optimization unit 115 calculates a loss value by substituting the loss function with a value.

The distance optimization unit 115, as a specific example, uses a loss function indicated in [Numerical Formula 3]. Details of [Numerical Formula 3] are disclosed in [Reference 1]. In [Numerical Formula 3], & is the distance between features and Φ is a degree of similarity among features at each time.

$$L = arg {min}_{ε , Φ} \frac{1}{\vert P \vert} {\sum }_{( {A}^{+} , {B}^{+} ∈ P )} log {S}_{{A}^{+} {B}^{+}} ( ε , Φ ) + \frac{1}{N} {\sum }_{( {A}^{-} , {B}^{-} ∈ N )} log ( 1 - {S}_{{A}^{-} {B}^{-}} ( ε , Φ ) ) \qquad [ Numerical Formula 3 ]$$

$${S}_{AB} = exp ( - {d}_{AB} )$$

The distance optimization unit 115, as a specific example, utilizes as the loss function, a function of which a SoftMax function and a Cos similarity are extended in a case where the distance that the distance calculation unit 114 calculated is angle θ_{yi} between vectors. The loss function is, as a specific example, AngularSoftmax indicated in [Numerical Formula 4]. Here, s indicates a scale and m indicates a margin. In [Numerical Formula 4], a parameter that is an optimization target is above-mentioned wⱼ, the convolution parameter, or the like. Details of [Numerical Formula 4] are disclosed in [Reference 2].

### [Reference 2]

Deng. et al., “ArcFace: Additive Angular Margin Loss for Deep Face Recognition”, Proceedings of the IEEE/CVF Conference on Computer Vision and Pattern Recognition (CVPR), 2019, pp. 4690-4699

$$L = - \frac{1}{N} {\sum }_{i = 1}^{N} log \frac{exp ( s \cdot cos ( {θ}_{{y}_{i}} + m ) )}{\begin{matrix}exp ( s \cdot cos ( {θ}_{{y}_{i}} + m ) ) + \\ {\sum }_{j = 1 , j \neq {y}_{i}}^{n} exp ( s \cdot cos ( {θ}_{j} ) )\end{matrix}} \qquad [ Numerical Formula 4 ]$$

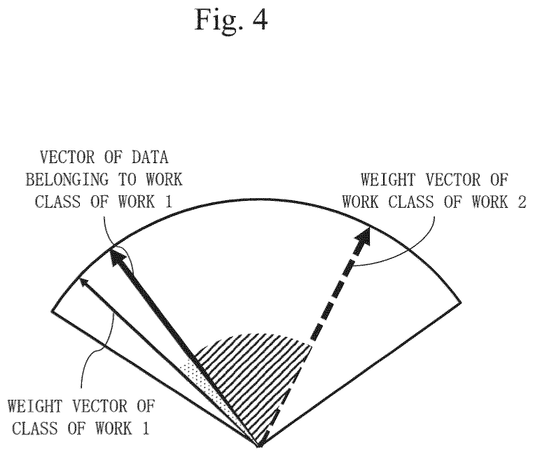

FIG. 4 is a diagram describing the loss function that is the function of which the SoftMax function and the Cos similarity are extended. In the loss function, a loss is calculated based on a magnitude relationship of angles that the weight vector corresponding to each work class and a feature vector form. The feature vector is generated by the waveform conversion unit 113 converting the joint movement data. Here, a margin is set in a way that a sum of an angle that is formed of a weight vector and a feature vector in a work class same as a target class that is a work class to which data corresponding to the feature vector belongs and the margin becomes smaller than an angle that an angle formed of a weight vector and a feature vector in a work class different from the target class.

Since a degree of similarity in a same work class can be made relatively large and a degree of similarity between work classes that differ from each other can be made relatively small by using the loss function, a classification function of data can be improved.

### (Step S106)

The distance optimization unit 115 optimizes the convolution parameter in a way that a loss value that the loss function indicates is minimized. The convolution parameter does not have to be a parameter that corresponds to an exact optimal value. The distance optimization unit 115 records the convolution parameter optimized in the parameter storage unit 122.

After that, the work estimation apparatus 100 carries out an increment in the number of learning times and returns to step S101.

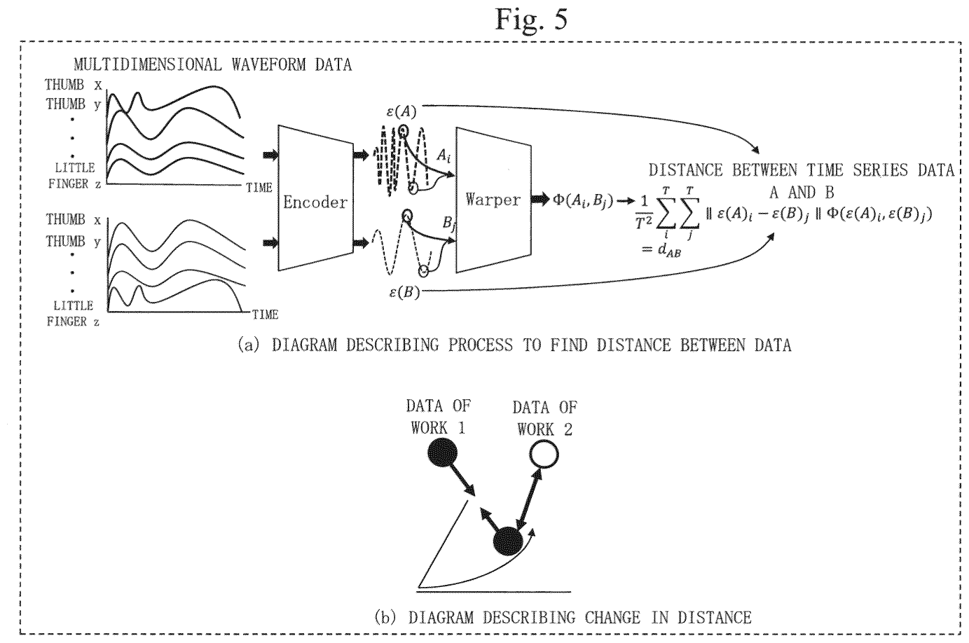

FIG. 5 is a diagram describing the process of the work estimation apparatus 100 at the time of learning.

In (a) of FIG. 5, Encoder generates a feature by convolving each of the two pieces of multidimensional waveform data in the time direction using the convolution parameter. Here, the feature generated is regarded as waveform data. Warper automatically determines time that values concerning two pieces of waveform data match based on a value weighted by convolving. After that, the distance calculation unit 114 calculates a distance between two pieces of waveform data using a value of the waveform data at each time and a matching degree, and the distance optimization unit 115 reflects the distance calculated to the loss function.

As a result, as illustrated in (b) of FIG. 5, the convolution parameter is optimized in a way that a distance between data indicating same work becomes relatively small and a distance between data indicating work that differ from each other becomes relatively large. Each of “work 1” and “work 2” in (b) of FIG. 5 are work labels. A process to optimize the convolution parameter is a process to optimize parameters of Encoder and Warper, and is a process to quantify a difference in the movement during work between the workers, and a process to control the difference by the parameter.

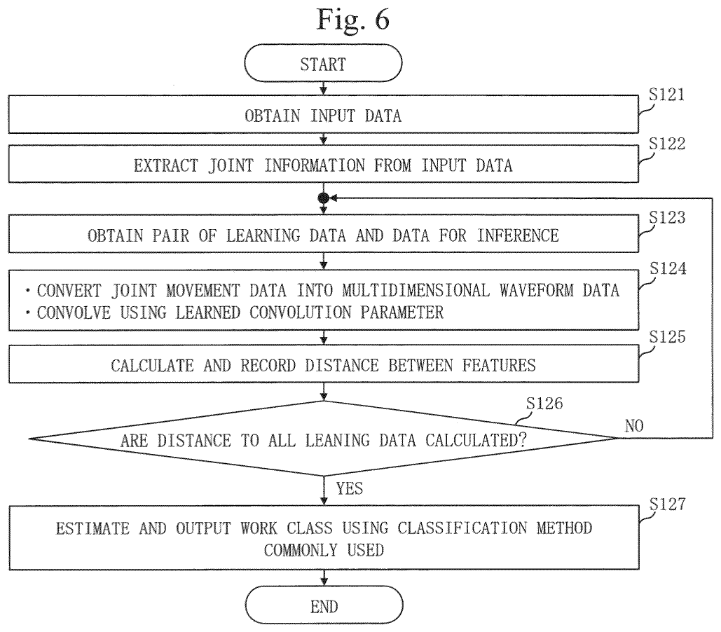

FIG. 6 is a flowchart illustrating an example of a process of the work estimation apparatus 100 at a time of inference. The process of the work estimation apparatus 100 at the time of inference will be described by referring to FIG. 6.

### (Step S121)

The joint information extraction unit 111 obtains the data that the data obtaining device 200 obtained as the input data.

### (Step S122)

The joint information extraction unit 111 extracts the joint movement data from the input data, and regards the joint movement data extracted as the inference target data.

### (Step S123)

The batch data obtaining unit 112 obtains a piece of joint movement data from the learning data storage unit 121, and outputs a pair of the joint movement data obtained and the inference target data extracted in step S122 to the waveform conversion unit 113.

### (Step S124)

The waveform conversion unit 113 converts each of the joint movement data that the batch data obtaining unit 112 outputted and the inference target data into multidimensional waveform data. After that, the waveform conversion unit 113 reads the convolution parameter from the parameter storage unit 122, and coverts each piece of multidimensional waveform data into a feature by convolving each piece of multidimensional waveform data using the convolution parameter read.

### (Step S125)

The distance calculation unit 114 calculates a distance between the features generated in step S124.

### (Step S126)

In a case where distances to the inference target data for all the joint movement data included in the learning data are calculated, the work estimation apparatus 100 proceeds to step S127. In other cases, the work estimation apparatus 100 proceeds to step S123.

### (Step S127)

The work estimation unit 116 estimates a work class corresponding to the inference target data using a classification technique commonly used. The information presentation unit 117 outputs information corresponding to the work class estimated by the work estimation unit 116.

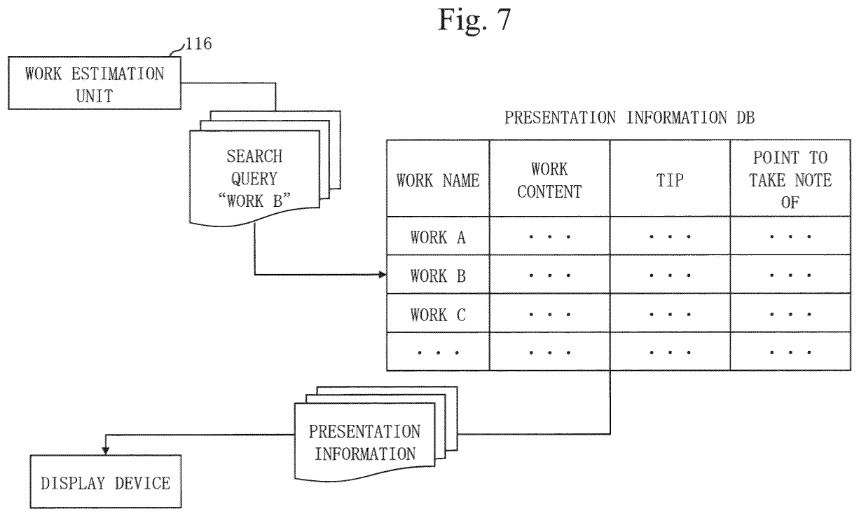

FIG. 7 is a diagram describing a process of the information presentation unit 117. The information presentation unit 117 accepts from the work estimation unit 116, information indicating a work name corresponding to the inference target data as a search query and searches work information DB that the presentation information storage unit 124 has stored using the search query accepted. The work name is a name given for the work content. In the work information DB, as a specific example, the work content and a tip and a precaution relating to the work are linked to the work name. After that, the information presentation unit 117 generates presentation information based on a result of searching, and outputs the presentation information generated to a display device. The display device may be the communication terminal 300.

The work recording unit 118 may record the work content estimated by the work estimation unit 116 and the date and the time that work corresponding to the work content estimated was executed to the work content storage unit 125.

### Description of Effect of Embodiment 1

As described above, according to the present embodiment, the work content can be estimated robustly with respect to a variation in the movement during work since the variation in the movement during work is quantified as a distance between time series data.

### Other Configurations

### <Variation 1>

Speed information of each joint will be made use of in the present variation. In the present variation, information indicating a speed of each joint is included in the multidimensional waveform data. The multidimensional waveform data according to the present variation may include information indicating a position and a speed of each joint of the worker.

The joint information extraction unit 111 according to the present variation calculates the speed of each joint based on the joint movement data, and generates multidimensional waveform data that includes data indicating the speed calculated. The joint information extraction unit 111 may combine the multidimensional waveform data indicating the speed of each joint with the multidimensional waveform data indicating the position of each joint.

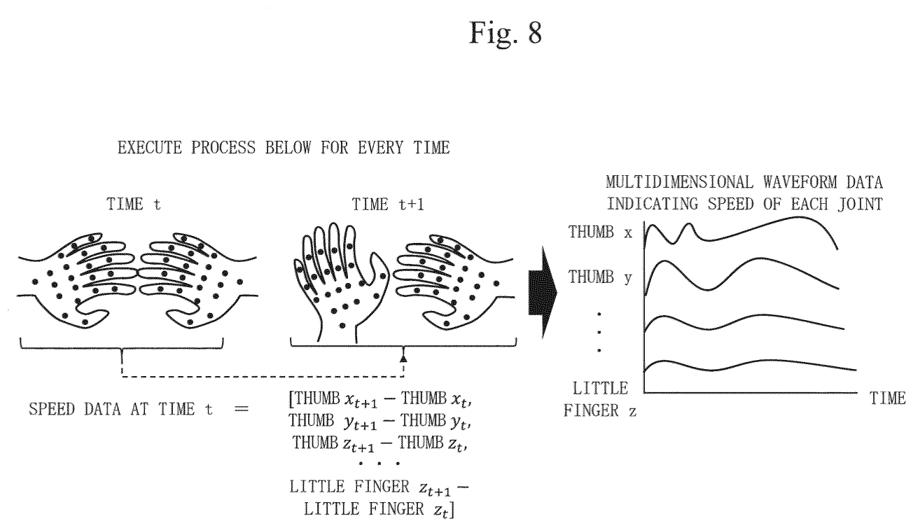

FIG. 8 is a diagram describing the present variation. The joint information extraction unit 111 finds a speed of each point at time t based on a difference between a position of each joint at time t and a position of each joint at time t+1, and generates multidimensional waveform data indicating the speed found.

According to the present variation, information on the movement that represents work can be precisely grasped and bringing an end of distance learning can be accelerated by making use of the speed information of the joint. According to the present variation, a classification function of data for each piece of work can be improved.

### <Variation 2>

In the present variation, the joint movement data is divided by body part, modal, or the like, a conversion process is performed with respect to each piece of data divided to find a feature corresponding to each piece of data, and each feature found is combined to regard as a final feature. The modal is, as a specific example, a position or a speed. The joint movement data according to the present variation includes information indicating the movement of each joint for each of at least one of the modal and the body part of the worker.

In step S103, the waveform conversion unit 113 divides the joint movement data into data for each body part, modal, or the like, coverts, for each piece of data divided, into the multidimensional waveform data, converts, for each piece of multidimensional waveform data converted, into a feature using the convolution parameter, combines features converted, and outputs a feature combined. The joint information extraction unit 111 and the like may divide the input data or the joint movement data.

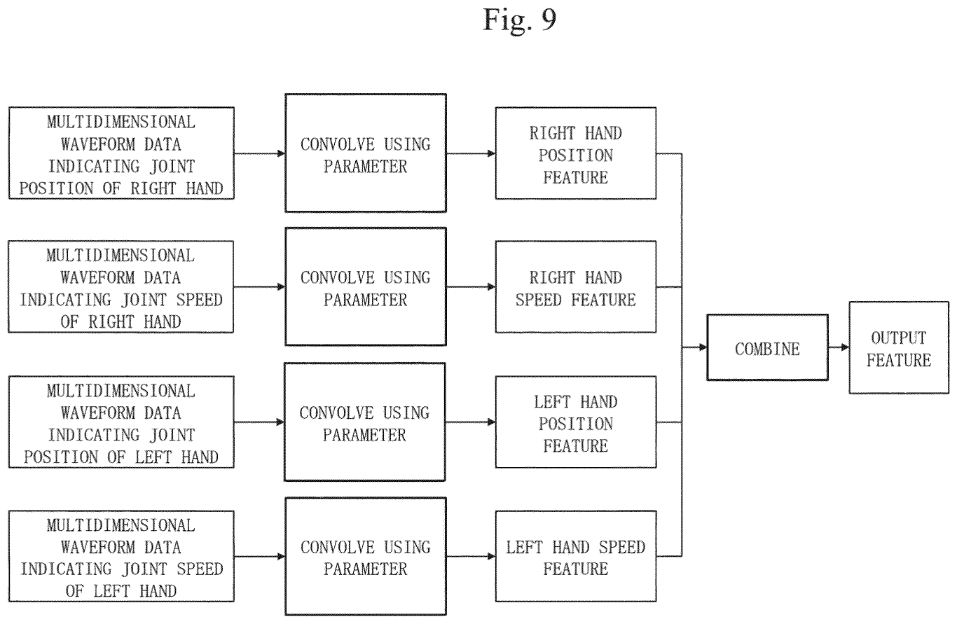

FIG. 9 is a diagram describing the present variation. The waveform conversion unit 113 divides the multidimensional waveform data that is the joint movement data converted into multidimensional waveform data indicating a joint position of a right hand, multidimensional waveform data indicating a joint speed of the right hand, multidimensional waveform data indicating a joint position of a left hand, and multidimensional waveform data indicating a joint speed of the left hand, finds a feature corresponding to each piece of multidimensional waveform data divided, and combines each feature found.

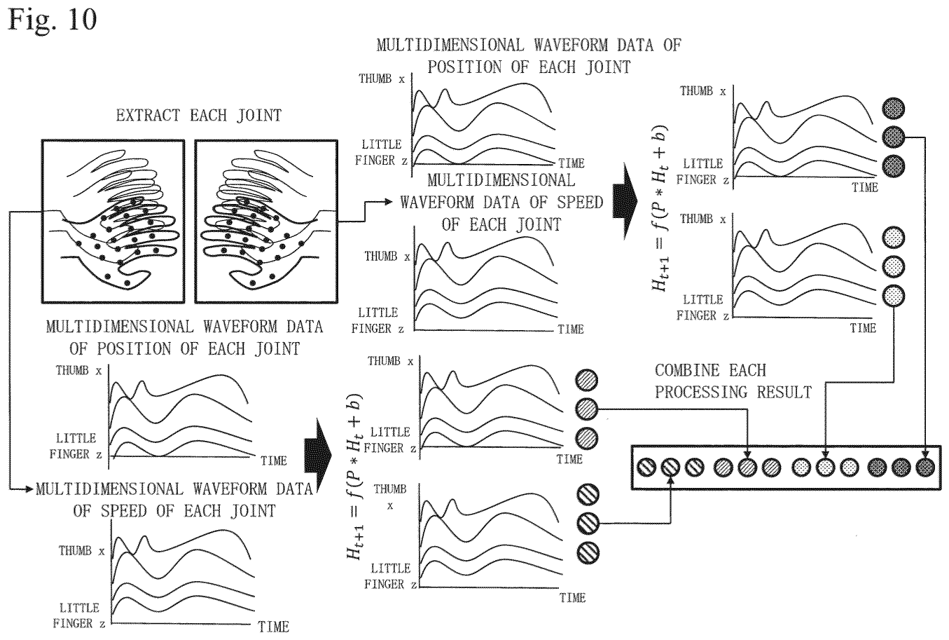

FIG. 10 is a diagram corresponding to the specific example illustrated in FIG. 9, and is a diagram describing the present variation. The waveform conversion unit 113 generates a feature vector for each body part and each modal, and combines each feature vector generated to regard as a final feature vector.

According to the present variation, since a higher-order feature becomes possible to be extracted, a classification function of data can be improved.

### <Variation 3>

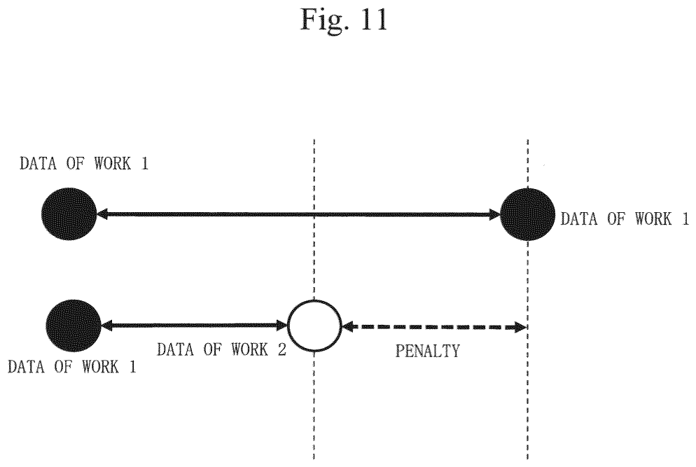

In the present variation, a penalty is added to the loss function, and the penalty added will be made use of for an adjustment of the convolution parameter. As illustrated in FIG. 11, the penalty is intended to add a margin in a way that a distance between data indicating same work content does not become larger than a distance between data indicating work content that differ from each other. In FIG. 11, in a case where there is no penalty, a distance between data corresponding to work 1 is larger than a distance between data corresponding to work 1 and data corresponding to work 2. A size and the like of the penalty may be determined in any way. By the loss function to which the penalty is added, the distance between the data indicating the same work content can be made relatively small, and the distance between the data indicating work that differ from each other can be made relatively large.

The distance optimization unit 115 according to the present variation, at a time of learning the convolution parameter, for a distance between each two pieces of joint movement data taken out from the learning data, the penalty is used in a way that a distance in a case where the work labels associated with each two pieces of joint movement data differ from each other become larger than a distance in a case where the work labels associated with each two pieces of joint movement data are a same.

[Numerical Formula 5] indicates a specific example of the loss function to which the penalty is added. Here, loss is the loss function, penalty is a function indicating the penalty, p is the convolution parameter, and λ is a balancer.

$$arg {min}_{p} cost ( p ) = arg {min}_{p} loss ( p ) + λ penalty ( p ) \qquad [ Numerical Formula 5 ]$$

$$loss ( p ) = exp ( - d ( {C}_{1} , {C}_{1} , p ) ) + 1 - exp ( - d ( {C}_{1} , {C}_{2} , p ) )$$

$$penalty ( p ) = max ( d ( {C}_{1} , {C}_{1} , p ) + margin - d ( {C}_{1} , {C}_{2} , p ) , 0 )$$

According to the present variation, by adding the penalty to the loss function, the distance within the same work class becomes relatively small and a distance between work classes that differ from each other becomes relatively large. Consequently, according to the present variation, a classification function of data can be improved.

### <Variation 4>

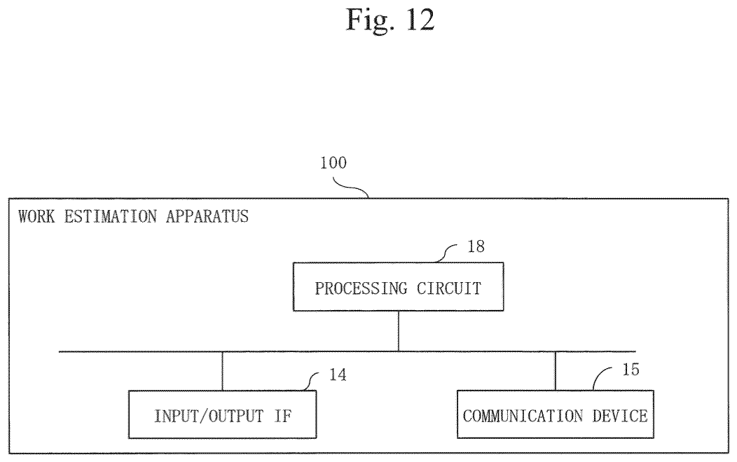

FIG. 12 illustrates an example of a hardware configuration of a work estimation apparatus 100 according to the present variation.

The work estimation apparatus 100 includes a processing circuit 18 instead of the processor 11, the processor 11 and the main storage device, the processor 11 and the auxiliary storage device, or the processor 11, the main storage device, and the auxiliary storage device.

The processing circuit 18 is hardware that enables at least a part of each unit that the work estimation apparatus 100 includes.

The processing circuit 18 may be dedicated hardware and may be a processor that executes a program stored in the main storage device.

In a case where the processing circuit 18 is dedicated hardware, the processing circuit 18 is, as a specific example, a single circuit, a composite circuit, a programmed processor, a parallel programmed processor, an ASIC (Application Specific Integrated Circuit), an FPGA (Field Programmable Gate Array), or a combination of these.

The work estimation apparatus 100 may include a plurality of processing circuits that replace the processing circuit 18. The plurality of processing circuits share roles of the processing circuit 18.

In the work estimation apparatus 100, a part of functions may be enabled by dedicated hardware and the rest of the functions may be enabled by software or firmware.

The processing circuit 18 is, as a specific example, enabled by hardware, software, firmware, or a combination of these.

The processor 11, the main storage device, the auxiliary storage device, and the processing circuit 18 are generically called “processing circuitry”. That is, functions of each functional element of the work estimation apparatus 100 are enabled by the processing circuitry.

As for the work estimation apparatus 100 according to other embodiments, the work estimation apparatus 100 may be in a same configuration as the configuration in the present variation.

### Other Embodiments

A description with regard to Embodiment 1 has been given, but within the present embodiment, a plurality of parts may be combined and executed. Or, the present embodiment may be executed partially. In addition, various changes may be made to the present embodiment as necessary, and the present embodiment may be arranged and executed in any manner, either fully or partially.

The embodiment mentioned above is an essentially preferred example, and is not intended to limit the present disclosure, the application of the present disclosure, and the scope of use. The procedures described using the flowcharts and the like may be suitably changed.

### REFERENCE SIGNS LIST

11: processor; 12: storage device; 14: input/output IF; 15: communication device; 18: processing circuit; 90: work estimation system; 100: work estimation apparatus; 111: joint information extraction unit; 112: batch data obtaining unit; 113: waveform conversion unit; 114: distance calculation unit; 115: distance optimization unit; 116: work estimation unit; 117: information presentation unit; 118: work recording unit; 121: learning data storage unit; 122: parameter storage unit; 123: estimation result storage unit; 124: presentation information storage unit; 125: work content storage unit; 200: data obtaining device; 300: communication terminal.

1. A work estimation apparatus comprising:
processing circuitry to:
calculate a distance between a feature of which, regarding joint movement data that is time series data indicating a temporal transition of a position of each joint of a worker during work as inference target data, the inference target data is converted into multidimensional waveform data, and converted by convolving the multidimensional waveform data converted using a convolution parameter indicating weight found by learning, and each feature of which each piece of joint movement data that configures a plurality of pieces of joint movement data for learning the convolution parameter is converted into multidimensional waveform data, and each piece of multidimensional waveform data converted is converted by convolving using the convolution parameter, and
estimate work content corresponding to the inference target data based on each distance calculated, wherein
the convolution parameter is a parameter learned, using a loss function, in a way that a distance between each two pieces of joint movement data taken out from learning data consisting of a plurality of pieces of joint movement data associated with work labels indicating work content becomes relatively small in a case where the work labels associated with each two pieces of joint movement data are a same, and relatively large in a case where the work labels associated with each two pieces of joint movement data differ from each other.

2. The work estimation apparatus according to claim 1, wherein
the loss function is a function based on a SoftMax function and a Cos similarity.

3. The work estimation apparatus according to claim 1, wherein
the multidimensional waveform data includes information indicating a position and a speed of each joint of a worker.

4. The work estimation apparatus according to claim 1, wherein
the joint movement data includes information indicating a movement of each joint for each of at least one of a modal and a body part of a worker.

5. The work estimation apparatus according to claim 1, wherein
the processing circuitry
learns the convolution parameter using the learning data.

6. The work estimation apparatus according to claim 5, wherein
the processing circuitry
at a time of learning the convolution parameter, for a distance between each two pieces of joint movement data taken out from the learning data, uses a penalty in a way that a distance in a case where work labels associated with each two pieces of joint movement data differ from each other become larger than a distance in a case where the work labels associated with each two pieces of joint movement data are a same.

7. The work estimation apparatus according to claim 1, wherein
the processing circuitry
generates presentation information that is information that relates to work content estimated, and that is information that is to be presented to a worker corresponding to the inference target data.

8. The work estimation apparatus according to claim 1, wherein
the processing circuitry
records work content estimated and date and time that work corresponding to the work content estimated was executed.

9. A work estimation method comprising:
calculating a distance between a feature of which, regarding joint movement data that is time series data indicating a temporal transition of a position of each joint of a worker during work as inference target data, the inference target data is converted into multidimensional waveform data, and converted by convolving the multidimensional waveform data converted using a convolution parameter indicating weight found by learning, and each feature of which each piece of joint movement data that configures a plurality of pieces of joint movement data for learning the convolution parameter is converted into multidimensional waveform data, and each piece of multidimensional waveform data converted is converted by convolving using the convolution parameter, by a computer; and
estimating work content corresponding to the inference target data based on each distance calculated, by the computer, wherein
the convolution parameter is a parameter learned, using a loss function, in a way that a distance between each two pieces of joint movement data taken out from learning data consisting of a plurality of pieces of joint movement data associated with work labels indicating work content becomes relatively small in a case where the work labels associated with each two pieces of joint movement data are a same, and relatively large in a case where the work labels associated with each two pieces of joint movement data differ from each other.

10. A non-transitory computer readable medium storing a work estimation program that causes a work estimation apparatus that is a computer to execute:
a distance calculation process to calculate a distance between a feature of which, regarding joint movement data that is time series data indicating a temporal transition of a position of each joint of a worker during work as inference target data, the inference target data is converted into multidimensional waveform data, and converted by convolving the multidimensional waveform data converted using a convolution parameter indicating weight found by learning, and each feature of which each piece of joint movement data that configures a plurality of pieces of joint movement data for learning the convolution parameter is converted into multidimensional waveform data, and each piece of multidimensional waveform data converted is converted by convolving using the convolution parameter; and
a work estimation process to estimate work content corresponding to the inference target data based on each distance calculated, wherein
the convolution parameter is a parameter learned, using a loss function, in a way that a distance between each two pieces of joint movement data taken out from learning data consisting of a plurality of pieces of joint movement data associated with work labels indicating work content becomes relatively small in a case where the work labels associated with each two pieces of joint movement data are a same, and relatively large in a case where the work labels associated with each two pieces of joint movement data differ from each other.
